(19) United States
(12) Patent Application Publication
(10) Pub. No.: US 2026/0263323 A1
(43) Pub. Date: Sep. 10, 2026

(54) MASSAGE DEVICE HAVING SEPARATION-TYPE PRESSING PART

(71) Applicant: CERAGEM Co., Ltd., Cheonan-si, Chungcheongnam-do (KR)

(72) Inventors: Ho Sang YU, Cheonan-si, Chungcheongnam-do (KR); Sang Cheol HAN, Cheonan-si, Chungcheongnam-do (KR); Jin Sung LEE, Anyang-si, Gyeonggi-do (KR); Dong Myoung LEE, Asan-si, Chungcheongnam-do (KR); Joong Keun AN, Suwon-si, Gyeonggi-do (KR); Jun KIM, Cheonan-si, Chungcheongnam-do (KR)

(73) Assignee: CERAGEM Co., Ltd., Cheonan-si, Chungcheongnam-do (KR)

(21) Appl. No.: 19/162,915

(22) PCT Filed: Mar. 6, 2024
(86) PCT No.: PCT/KR2024/002891

§ 371 Date: Sep. 5, 2025

(30) Foreign Application Priority Data
Mar. 8, 2023 (KR) 10-2023-0030275

(51) Int. Cl. A61H 39/04; A61H 1/00; A61H 15/00

(52) U.S. Cl. CPC A61H 39/04; A61H 1/008; A61H 15/00; A61H 2015/0014; A61H 2201/1623; A61H 2201/5007; A61H 2205/081; A61H 2230/625

(57) ABSTRACT

The present invention relates to a massage device. More specifically, a massage device having a separation-type pressing part is disclosed. The massage device having a separation-type pressing part, according to one aspect of the present invention, comprises: a pressing part having a first pressing member and a second pressing member that are provided in the width direction so as to press the body of a user, and having a first pressing plate member and a second pressing plate member that support the first pressing member and the second pressing member, respectively; and a lifting/lowering part having a first lifting/lowering member and a second lifting/lowering member that lift/lower the first pressing plate member and the second pressing plate member, respectively, and having a first lifting/lowering driving member and a second lifting/lowering driving member that provide driving force of the first lifting/lowering member and the second lifting/lowering member, respectively.

### TECHNICAL FIELD

The present invention relates to a massage device, and more particularly, to a massage device having a separation-type pressing part.

### BACKGROUND

In the related art, spinal thermotherapy devices have been widely used which move along a part of the body to apply heat stimulation to an area of pain in order to relieve acute or chronic pain occurring in muscles and nerve tissue of the spinal region caused by continuing to work in an improper posture for a long time or by habitual adoption of such posture, to improve blood circulation in the body, or to relieve momentary muscle stiffness, thereby improving blood flow.

These spinal thermotherapy devices are provided with a pressing member for pressing the body of a user, and the pressing degree (massage intensity) applied to the user's body is adjusted by raising or lowering the pressing member to control its height.

In this case, the pressing members are disposed opposite to each other on both sides in the width direction with respect to the user's spine so as to press acupressure points along the Bladder meridian (Zutaiyangpangguangjing).

Such spinal thermotherapy devices adjust the height of the pressing members by simultaneously raising or simultaneously lowering the pressing members that are disposed opposite to each other on both sides in the width direction with respect to the user's spine. For this purpose, a single supporting member is provided, on which the pressing members are arranged.

In other words, the height of the pressing members disposed opposite to each other on both sides in the width direction is adjusted simultaneously by controlling the height of the single supporting member. With such a configuration, appropriate massage can be provided to a user whose body is symmetrical on both sides with respect to the spine. However, there arises a problem in that appropriate massage cannot be provided to a user whose body is asymmetrical on both sides with respect to the spine (for example, a user having scoliosis).

In addition, the supporting member is provided with a load measuring member for measuring a load applied from the user's body. In the case of a user whose body is symmetrical on both sides with respect to the spine, the loads on both sides in the width direction are applied uniformly to the pressing members, and thus the load applied to each of the pressing members can be accurately calculated through the average value of the loads. However, in the case of a user whose body is asymmetrical on both sides with respect to the spine, the loads applied to one side and the other side in the width direction differ, and therefore, with the above-described method, it is difficult to accurately calculate the load applied to each of the pressing members, respectively.

Therefore, there is a need for the development of a technology capable of solving these problems.

### DISCLOSURE

### Technical Problem

The present invention is to solve the above problems, and the present invention is directed to providing a massage device having a separation-type pressing part, which can provide appropriate massage not only to a user having a body symmetrical on both sides in the width direction with respect to the spine, but also to a user having a body asymmetrical on both sides in the width direction.

The problems of the present invention are not limited to those mentioned above, and other problems not mentioned will be clearly understood by those of ordinary skill in the art from the following description.

### Technical Solution

According to one aspect of the present invention, provided is a massage device having a separation-type pressing part, including a pressing part including a first pressing member and a second pressing member provided along a width direction to press a user's body, and a first pressing plate member and a second pressing plate member respectively supporting the first pressing member and the second pressing member; a lifting/lowering part including a first lifting/lowering member and a second lifting/lowering member respectively configured to lift or lower the first pressing plate member and the second pressing plate member, and a first lifting/lowering driving member and a second lifting/lowering driving member respectively providing driving forces to the first lifting/lowering member and the second lifting/lowering member; and a transfer part including a transfer plate member on which the pressing part and the lifting/lowering part are disposed, and a transfer driving member providing a driving force such that the transfer plate member moves along a longitudinal direction.

In this case, the first pressing plate member and the second pressing plate member may each include a body on which the first pressing member and the second pressing member are respectively disposed; and a leg extending from the body and hinge-fixed to the transfer plate member.

In this case, the leg may include a first leg disposed outward in the width direction and a second leg disposed inward in the width direction.

In this case, a first hinge shaft may be provided in the first leg to be hinge-fixed to the transfer plate member, and a second hinge shaft may be provided in the second leg to be hinge-fixed to the transfer plate member.

In this case, the second hinge shaft may be disposed to simultaneously penetrate the second legs that are disposed adjacent to each other.

In this case, an outer side in the width direction of the first hinge shaft may be fixed to the transfer plate member, and the first leg may be fixed to an inner side in the width direction of the first hinge shaft, and both sides in the width direction of the second hinge shaft may be fixed to the transfer plate member, and the second leg may be fixed to an inner side in the width direction of the second hinge shaft.

In this case, the first lifting/lowering member and the second lifting/lowering member may respectively support lower surfaces of the first pressing plate member and the second pressing plate member, but support positions inwardly shifted from widthwise centers of the first pressing plate member and the second pressing plate member.

In this case, the massage device may further include a load detection part including load detection members respectively provided in the first pressing member and the second pressing member to respectively measure loads applied to the first pressing member and the second pressing member; and a control unit configured to control operations of the lifting/lowering part and the transfer part based on signals transmitted through the load detection part.

In this case, the control unit may be configured to move the transfer plate member in the longitudinal direction while maintaining the height direction positions of the first pressing member and the second pressing member fixed, and measure the degree of spinal scoliosis of a user based on signals respectively transmitted through the load detection members respectively provided in the first pressing member and the second pressing member.

In this case, the control unit may be configured to identify a first section in which loads applied to the first pressing member and the second pressing member are identical, and a second section in which loads applied to the first pressing member and the second pressing member are different, and collect spinal scoliosis data of the user.

In this case, the control unit may be configured to move the transfer plate member in the longitudinal direction while maintaining the height direction positions of the first pressing member and the second pressing member fixed, and measure the degree of spinal scoliosis of the user by utilizing a change in the height direction positions of the first pressing member and the second pressing member caused by a load applied from the user.

In this case, the control unit may be configured to identify a first section in which height direction positions of the first pressing member and the second pressing member are identical, and a second section in which the height direction positions of the first pressing member and the second pressing member are different, and to collect spinal scoliosis data of the user.

In this case, the control unit may be configured to control the height direction positions of the first pressing member and the second pressing member to be identical when the pressing part passes through the first section, and control the height direction positions of the first pressing member and the second pressing member to be different so that pressing forces on one side and the other side in the width direction are different when the pressing part passes through the second section.

In this case, when the user selects a massage mode and inputs a desired pressing force, the control unit may be configured to adjust the height direction positions of the first pressing member and the second pressing member to be identical so that the pressing force is applied while the pressing part passes through the first section, and adjust the height direction positions of the first pressing member and the second pressing member to be different respectively so that the pressing force is applied while the pressing part passes through the second section.

In this case, when the user selects a correction mode, the control unit may be configured to identify one of the first pressing member and the second pressing member to which a relatively smaller load is applied and the other of the first pressing member and the second pressing member to which a relatively larger load is applied, based on the collected spinal scoliosis data of the user, and control the height direction position of one of the pressing members to be fixed and the height direction position of the other of the pressing members to be increased.

### Advantageous Effect

According to the configuration, the massage device having a separation-type pressing part according to an exemplary embodiment of the present invention is provided with a first pressing plate member that supports the first pressing member disposed on one side in the width direction with respect to the user's spine, and a second pressing plate member that supports the second pressing member disposed on the other side in the width direction. The massage device is also provided with a first lifting/lowering member and a first lifting/lowering driving member for raising or lowering the first pressing plate member, and a second lifting/lowering member and a second lifting/lowering driving member for raising or lowering the second pressing plate member. Accordingly, it is possible to raise or lower the first pressing member and the second pressing member independently of each other, thereby providing an appropriate massage even to a user whose body is asymmetrical on both sides in the width direction, and thus maximizing the massage effect.

In addition, since the load detection members respectively measuring the loads applied to the first pressing member and the second pressing member are provided, it is possible to accurately measure the loads applied from a user whose body is asymmetrical on both sides in the width direction, and by reflecting this, it is possible to press the body of the user, thereby maximizing the massage effect.

Furthermore, since the first pressing member and the second pressing member can be independently raised or lowered, the spine of a user whose body is asymmetrical in the width direction can also be corrected.

Advantageous effects of the present invention are not limited to the above-described effects, and should be understood to include all effects that can be inferred from the configuration of the invention described in the detailed description or claims of the present invention.

### BRIEF DESCRIPTION OF THE DRAWINGS

FIG. 1 is a perspective view of a massage device according to an exemplary embodiment of the present invention, illustrating a state in which a pressing part is lowered.

FIG. 2 is a side view of a massage device according to an exemplary embodiment of the present invention, illustrating a state in which the pressing part is lowered.

FIG. 3 is a perspective view of a massage device according to an exemplary embodiment of the present invention, illustrating a state in which the pressing part is raised.

FIG. 4 is a side view of a massage device according to an exemplary embodiment of the present invention, illustrating a state in which the pressing part is raised.

FIG. 5 is a perspective view of a massage device according to an exemplary embodiment of the present invention, illustrating first and second lifting/lowering members and first and second lifting/lowering driving members.

FIG. 6 is a plan view of a massage device according to an exemplary embodiment of the present invention, illustrating a hinge-fixed state of first and second pressing plate members.

FIG. 7 is a side view of a massage device according to an exemplary embodiment of the present invention, illustrating a state in which a load detection part is installed.

FIG. 8 is a schematic view illustrating the spinal condition of a user having scoliosis.

FIG. 9 is a perspective view of a massage device according to an exemplary embodiment of the present invention, illustrating a state in which a pressing member disposed on one side in the width direction is raised.

FIG. 10 is a perspective view of a massage device according to an exemplary embodiment of the present invention, illustrating a state in which a pressing member disposed on the other side in the width direction is raised.

### MODES OF THE INVENTION

Hereinafter, exemplary embodiments of the present invention will be described in detail so that those of ordinary skill in the art can readily implement the present invention with reference to the accompanying drawings. The present invention may be embodied in many different forms and is not limited to the embodiments set forth herein. In the drawings, parts unrelated to the description are omitted for clarity of description of the present invention, and throughout the specification, same or similar reference numerals denote same elements.

The words and terms used in the present specification and claims should not be interpreted as being limited to their ordinary or dictionary meanings, but should be construed as having meanings and concepts consistent with the technical spirit of the present invention, in accordance with the principle that an inventor may define terms and concepts to best describe their invention.

Accordingly, the embodiments described in the present specification and the configurations shown in the drawings correspond to preferred embodiments of the present invention, and do not represent all the technical spirit of the present invention, so the configurations may have various examples of equivalent and modification that can replace them at the time of filing the present invention.

It should be understood that the terms “comprise or include” or “have” or the like when used in this specification, are intended to describe the presence of stated features, numbers, steps, operations, elements, components and/or a combination thereof but not preclude the possibility of the presence or addition of one or more other features, numbers, steps, operations, elements, components, or a combination thereof.

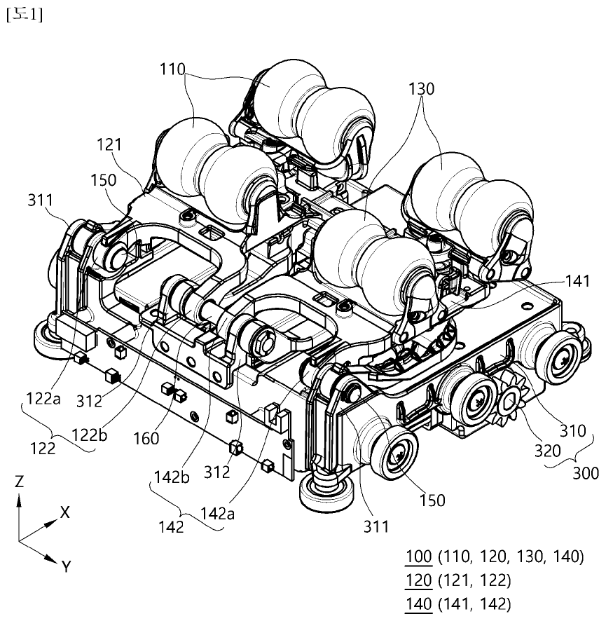

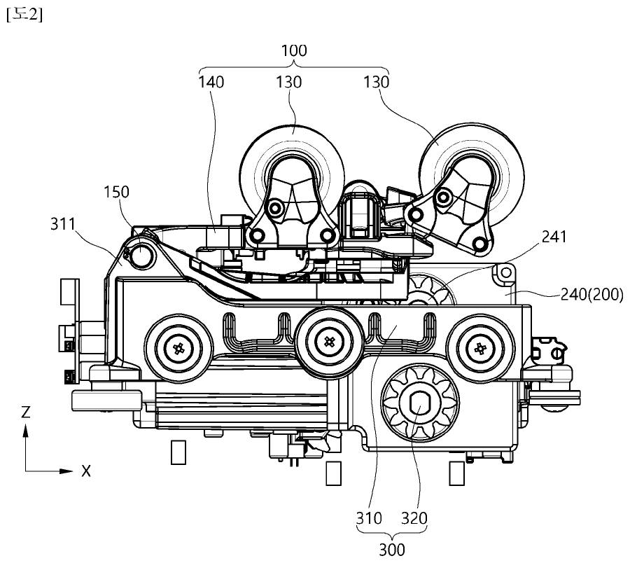

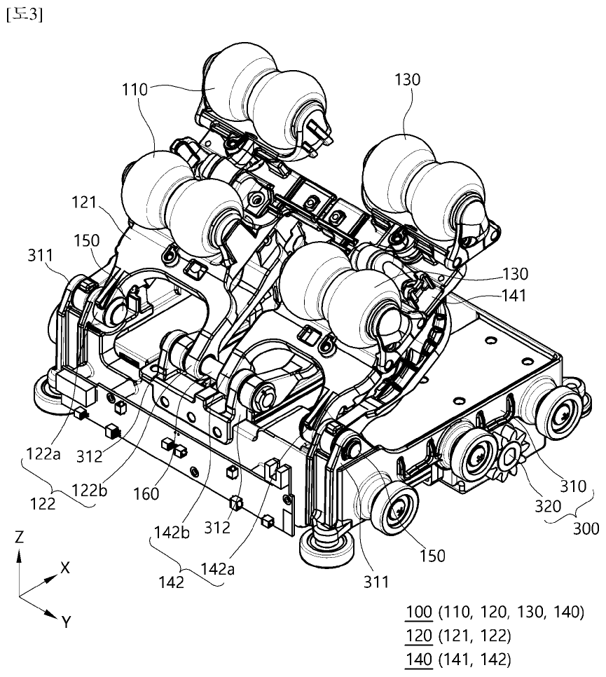

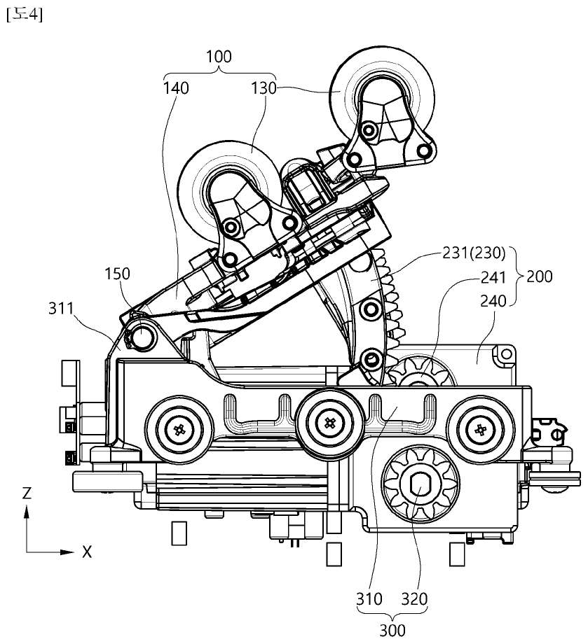

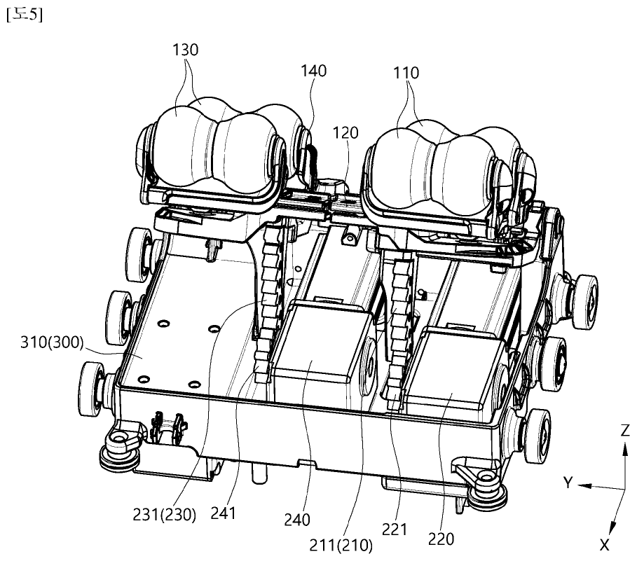

FIG. 1 is a perspective view of a massage device according to an exemplary embodiment of the present invention, illustrating a state in which a pressing part is lowered, FIG. 2 is a side view of a massage device according to an exemplary embodiment of the present invention, illustrating a state in which the pressing part is lowered, FIG. 3 is a perspective view of a massage device according to an exemplary embodiment of the present invention, illustrating a state in which the pressing part is raised, FIG. 4 is a side view of a massage device according to an exemplary embodiment of the present invention, illustrating a state in which the pressing part is raised, and FIG. 5 is a perspective view of a massage device according to an exemplary embodiment of the present invention, illustrating first and second lifting/lowering members and first and second lifting/lowering driving members. Here, the X-direction is the longitudinal direction (the same direction as the arrangement of the user's spine), the Y-direction is the width direction, which is divided into one side and the other side with respect to the user's spine, and the Z-direction is the height direction, which is the direction in which the pressing part is raised or lowered to adjust the pressing degree applied to the user's body.

As illustrated in FIGS. 1 to 4, a massage device having a separation-type pressing part according to an exemplary embodiment of the present invention includes a pressing part 100 having a first pressing member 110 and a second pressing member 130 provided along the width direction (Y) so as to press the body of a user, and having a first pressing plate member 120 and a second pressing plate member 140 that respectively support the first pressing member 110 and the second pressing member 130; a lifting/lowering part 200 having a first lifting/lowering member 210 and a second lifting/lowering member 230 that respectively raise or lower the first pressing plate member 120 and the second pressing plate member 140, and having a first lifting/lowering driving member 220 and a second lifting/lowering driving member 240 that respectively provide driving force to the first lifting/lowering member 210 and the second lifting/lowering member 230, respectively; and a transfer part 300 having a transfer plate member 310 on which the pressing part 100 and the lifting/lowering part 200 are disposed, and a transfer driving member 320 that provides driving force to move the transfer plate member 310 along the longitudinal direction (X).

Such a massage device may be inserted and disposed in a pad that supports the body of a user, and in this state of being inserted into the pad, the massage device moves along the longitudinal direction (X) while pressing the body of the user.

The pad may be provided in a main body part that supports the upper body of the user, and an auxiliary part that supports the lower body of the user may be connected to the main body part. In this case, the main body part may be configured to support not only the upper body of the user but also the hips, and the auxiliary part may be configured to support only the legs of the user.

In this case, the pad may also be provided in the auxiliary part that supports the lower body of the user, and it is also possible to configure both the main body part and the auxiliary part to be provided with pads.

The main body part provided with the pad may further include a separate leg member so that the upper surface of the pad is spaced apart from the ground, thereby allowing the user to receive a massage in a comfortable posture.

Such a leg member may be manufactured in an approximately rectangular band shape. That is, it may include a side frame corresponding to a side surface of the main body part, a lower frame supported on the ground, and a connecting frame connecting the side frame and the lower frame. The above-described frames may be made integrally, or may be combined after being made separately. Here, the side frame may be made in a plate shape, and the lower frame may be made in a rod shape.

In the above-described main body part, a guide groove may be formed, and in the auxiliary part, a guide protrusion to be inserted into the guide groove may be formed so that the auxiliary part can slide. Alternatively, the guide groove may be formed in the auxiliary part, and the guide protrusion may be formed in the main body part so that the auxiliary part can slide.

The first pressing member 110 and the second pressing member 130 may be provided with separate heating members to provide a thermotherapy massage effect to the user. The first pressing member 110 may be disposed on one side in the width direction (Y) with respect to the center of the width direction (Y) where the user's spine is arranged, and the second pressing member 130 may be disposed on the other side in the width direction (Y). Through this configuration, it is possible to provide a massage effect while pressing the acupressure points (e.g., acupressure points according to the bladder meridian) located on both sides along the user's spine.

The first pressing member 110 is disposed on the upper surface of the first pressing plate member 120, and the second pressing member 130 is disposed on the upper surface of the second pressing plate member 140. The first pressing plate member 120 and the second pressing plate member 140 may be hinge-fixed to the transfer plate member 310. That is, when the first pressing plate member 120 and the second pressing plate member 140 are raised through the operation of the lifting/lowering part 200, the first pressing member 110 and the second pressing member 130 are also raised. Since the first pressing plate member 120 and the second pressing plate member 140 are hinge-fixed, the first pressing member 110 and the second pressing member 130 are raised along an arc, and thus it is possible to provide both the effect of pressing in the height direction (Z) and the effect of pushing in the longitudinal direction (X), thereby enhancing the thermotherapy massage effect.

As illustrated in FIG. 5, the first lifting/lowering member 210 may be a first rack gear 211 disposed on one side in the width direction (Y) so as to raise or lower the first pressing plate member 120, and the second lifting/lowering member 230 may be a second rack gear 231 disposed on the other side in the width direction (Y) so as to raise or lower the second pressing plate member 140.

In addition, the first lifting/lowering driving member 220 and the second lifting/lowering driving member 240 may be driving motors for providing driving force, and each of the driving motors may be provided with a pinion connected to a driving shaft of the driving motor. The pinions may include a first pinion gear 221 that rotates together with the driving shaft of the first lifting/lowering driving member 220, and a second pinion gear 241 that rotates together with the driving shaft of the second lifting/lowering driving member 240. When the first pinion gear 221 and the second pinion gear 241 rotate in one direction or the other direction according to the rotation of the respective driving shafts, the first rack gear 211 and the second rack gear 231 may be raised or lowered, respectively.

As illustrated in FIG. 1, the transfer part 300 may be provided with a plate-shaped transfer plate member 310 on which the pressing part 100 and the lifting/lowering part 200 are disposed, and base ribs may be provided at both ends of the transfer plate member 310 in the width direction (Y). Support rollers may be provided on the base ribs, and the support rollers may be disposed so as to be movable along guide rails arranged in the longitudinal direction (X). In addition, the transfer part 300 may be provided with a transfer driving member 320 that provides driving force for moving the support rollers along the guide rails.

As described above, the massage device is provided with a first pressing plate member 120 that supports the first pressing member 110 disposed on one side in the width direction (Y) with respect to the user's spine, and a second pressing plate member 140 that supports the second pressing member 130 disposed on the other side in the width direction (Y). The massage device is also provided with a first lifting/lowering member 210 and a first lifting/lowering driving member 220 for raising or lowering the first pressing plate member 120, and a second lifting/lowering member 230 and a second lifting/lowering driving member 240 for raising or lowering the second pressing plate member 140. Accordingly, it is possible to raise or lower the first pressing member 110 and the second pressing member 130 independently of each other, thereby providing an appropriate massage even to a user whose body is asymmetrical on both sides in the width direction (Y), and thus maximizing the massage effect.

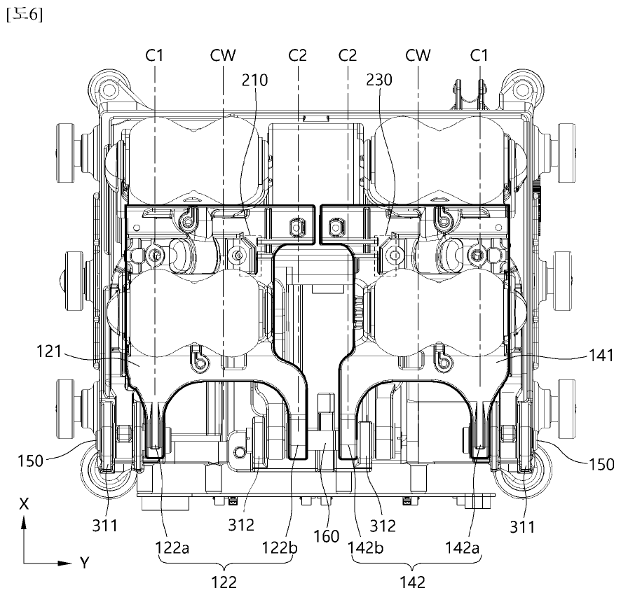

FIG. 6 is a plan view of a massage device according to an exemplary embodiment of the present invention, illustrating a hinge-fixed state of first and second pressing plate members.

As illustrated in FIG. 6, the first pressing plate member 120 and the second pressing plate member 140 may each include a body 121, 141 on which the first pressing member 110 and the second pressing member 130 are respectively disposed, and legs 122, 142 that respectively extend from the bodies 121, 141 and are hinge-fixed to the transfer plate member 310.

That is, as the legs 122, 142 are hinge-fixed to the transfer plate member 310, the bodies 121, 141 are raised along an arc, and accordingly, the first pressing member 110 and the second pressing member 130 that are respectively disposed on the upper surfaces of the bodies 121, 141 are also raised along an arc. Thus, it is possible to provide both the effect of pressing in the height direction (Z) and the effect of pushing in the longitudinal direction (X), thereby enhancing the thermotherapy massage effect.

As illustrated in FIG. 6, the legs 122 and 142 may include first legs 122a, 142a disposed on the outer side in the width direction (Y) and second legs 122b, 142b disposed on the inner side in the width direction (Y).

That is, since the inner and outer sides in the width direction (Y) of the bodies 121 and 141 are hinge-fixed by the first legs 122a, 142a and the second legs 122b, 142b, the bodies 121 and 141 can be maintained in a horizontal state without tilting to either side in the width direction (Y) even when the user's body weight is applied to the first pressing member 110 and the second pressing member 130, respectively, thereby making it possible for the first pressing member 110 and the second pressing member 130 to accurately press the correct position of the user's body.

As illustrated in FIG. 6, a first hinge shaft 150 may be provided on the first legs 122a and 142a so as to be hinge-fixed to the transfer plate member 310, and a second hinge shaft 160 may be provided on the second legs 122b and 142b so as to be hinge-fixed to the transfer plate member 310.

That is, the first legs 122a and 142a provided on the first pressing plate member 120 and the second pressing plate member 140 are respectively hinge-fixed to the transfer plate member 310 through the first hinge shaft 150, and the second legs 122b and 142b provided on the first pressing plate member 120 and the second pressing plate member 140 are respectively hinge-fixed through the second hinge shaft 160.

In this case, the second hinge shaft 160 may be arranged to simultaneously penetrate the second legs 122b and 142b that are disposed adjacent to each other. With this configuration, it is possible to hinge-fix both the second legs 122b and 142b provided on the first pressing plate member 120 and the second legs 122b and 142b provided on the second pressing plate member 140 at the same time by using a single second hinge shaft 160, thereby improving manufacturability.

As illustrated in FIG. 6, the first hinge shaft 150 may have its outer side in the width direction (Y) fixed to the transfer plate member 310, and the first legs 122a and 142a may be fixed to the inner side in the width direction (Y) of the first hinge shaft 150. The second hinge shaft 160 may have both sides in the width direction (Y) fixed to the transfer plate member 310, and the second legs 122b and 142b may be fixed to the inner side in the width direction (Y) of the second hinge shaft 160.

In this case, the transfer plate member 310 may be provided with an outer support rib 311 for fixing the first hinge shaft 150 and an inner support rib 312 for fixing the second hinge shaft 160.

The first legs 122a and 142a are disposed on the inner side in the width direction (Y) of the outer support rib 311, and in this state, the first hinge shaft 150 penetrates the outer support rib 311 and the first legs 122a and 142a so that the first legs 122a and 142a are hinge-fixed.

In addition, the second legs 122b and 142b provided on the first pressing plate member 120 and the second legs 122b and 142b provided on the second pressing plate member 140 are disposed on the inner side in the width direction (Y) of a pair of inner support ribs 312 that are arranged to face each other, and in this state, the second hinge shaft 160 simultaneously penetrates the pair of inner support ribs 312 and each of the second legs 122b and 142b so that the second legs 122b and 142b are hinge-fixed.

As illustrated in FIG. 6, the first lifting/lowering member 210 and the second lifting/lowering member 230 may respectively support the lower surfaces of the first pressing plate member 120 and the second pressing plate member 140, but may support positions inwardly shifted from the widthwise (Y) centers CW of the first pressing plate member 120 and the second pressing plate member 140.

That is, with reference to the width direction (Y), the first lifting/lowering member 210 is disposed so as to be farther from the center C1 of the first legs 122a and 142a of the first pressing plate member 120 and at the same time closer to the center C2 of the second legs 122b and 142b. In addition, with reference to the width direction (Y), the second lifting/lowering member 230 is also disposed so as to be farther from the center C1 of the first legs 122a and 142a of the second pressing plate member 140 and at the same time closer to the center C2 of the second legs 122b and 142b.

For this purpose, the first lifting/lowering member 210 and the second lifting/lowering member 230 are disposed on the inner side in the width direction (Y) of the transfer plate member 310, and the first lifting/lowering driving member 220 and the second lifting/lowering driving member 240 that provide driving force to the first lifting/lowering member 210 and the second lifting/lowering member 230 are also required to be disposed on the inner side in the width direction (Y) of the transfer plate member 310. With such a configuration, since the center of gravity is positioned on the inner side in the width direction (Y), the transfer plate member 310 does not tilt to either side in the width direction (Y), thereby making it possible to accurately press the correct position of the user's body.

However, in the case of the first pressing plate member 120, since the first lifting/lowering member 210 is disposed shifted inward in the width direction (Y) of the transfer plate member 310, the inner side in the width direction (Y) of the first pressing plate member 120 can be stably supported. However, it is also necessary to configure the structure so that the first pressing plate member 120 can be stably supported with respect to a load applied to the outer side in the width direction (Y) of the first pressing plate member 120.

That is, a load applied in the height direction (Z) to the outer side in the width direction (Y) of the first pressing plate member 120 can be stably supported by the structural rigidity of the first pressing plate member 120, but it is also necessary to ensure stable support even when a moment is generated due to such a load. When such a moment is generated, the second leg 122b is subjected to a moment that tends to move it upward about an extension line connecting the first lifting/lowering member 210 and the first leg 122a. In this case, since both sides of the second hinge shaft 160, to which the second leg 122b is hinge-fixed, are fixed by the pair of inner support ribs 312 as described above, stable support can be achieved even when such a moment is applied.

In the case of the second pressing plate member 140 as well, since the second lifting/lowering member 230 is disposed shifted inward in the width direction (Y) of the transfer plate member 310, the inner side in the width direction (Y) of the second pressing plate member 140 can be stably supported. However, it is also necessary to configure the structure so that the second pressing plate member 140 can be stably supported with respect to a load applied to the outer side in the width direction (Y) of the second pressing plate member 140. When a moment is generated due to a load applied in the height direction (Z) to the outer side in the width direction (Y) of the second pressing plate member 140, the second leg 142b is subjected to a moment that tends to move it upward about an extension line connecting the second lifting/lowering member 230 and the first leg 142a. In this case, since both sides of the second hinge shaft 160, to which the second leg 142b is hinge-fixed, are fixed by the pair of inner support ribs 312, stable support can be achieved even when such a moment is applied.

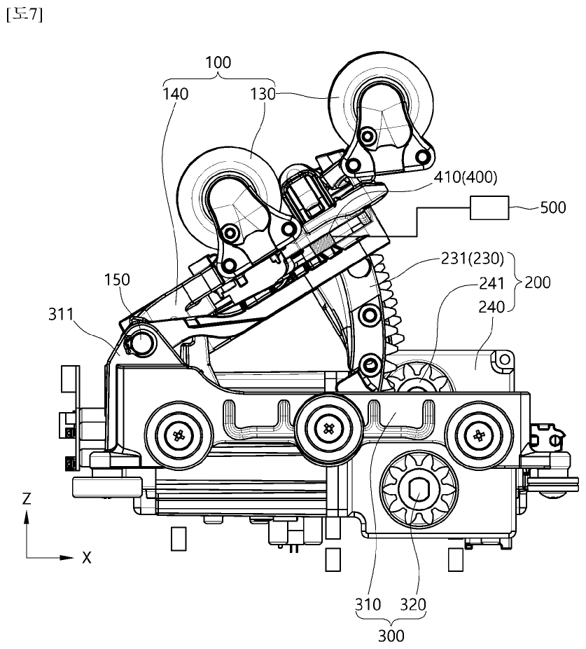

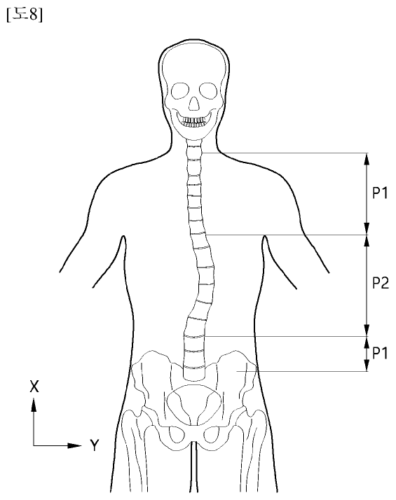

FIG. 7 is a side view of a massage device according to an exemplary embodiment of the present invention, illustrating a state in which a load detection part is installed, and FIG. 8 is a schematic view illustrating the spinal condition of a user having scoliosis.

As illustrated in FIG. 7, the massage device may further include a load detection part 400 provided with load detection members 410 that respectively measure the loads applied to the first pressing member 110 and the second pressing member 130, and a control unit 500 that controls the operation of the lifting/lowering part 200 and the transfer part 300 based on signals transmitted through the load detection part 400.

That is, since the load detection members 410 respectively measuring the loads applied to the first pressing member 110 and the second pressing member 130 are provided, it is possible to accurately measure the loads applied from a user whose body is asymmetrical on both sides in the width direction (Y), and by reflecting this, it is possible to press the body of the user, thereby maximizing the massage effect.

As illustrated in FIG. 7, the control unit 500 may move the transfer plate member 310 in the longitudinal direction (X) while maintaining the height direction (Z) positions of the first pressing member 110 and the second pressing member 130 fixed, and may measure the degree of spinal scoliosis of the user based on signals respectively transmitted through the load detection members 410 respectively provided on the first pressing member 110 and the second pressing member 130.

That is, when the spine is normally aligned along the longitudinal direction (X), the load detection members 410 respectively provided on the first pressing member 110 and the second pressing member 130 detect the same load. However, as illustrated in FIG. 8, when the spine is arranged to be shifted to one side in the width direction (Y) over a certain section, the load detection members 410 respectively provided on the first pressing member 110 and the second pressing member 130 detect different loads, and the device is configured to measure the degree of spinal scoliosis of the user based on this. Thus, it is possible to easily determine the degree of spinal scoliosis of the user without using expensive equipment.

In this case, it is possible to determine the degree of spinal scoliosis of the user through the difference between the loads detected by the load detection members 410 respectively provided on the first pressing member 110 and the second pressing member 130.

As illustrated in FIG. 8, the control unit 500 may identify a first section P1 in which the loads applied to the first pressing member 110 and the second pressing member 130 are the same, and a second section P2 in which the loads applied to the first pressing member 110 and the second pressing member 130 are different, and may collect spinal scoliosis data of the user.

That is, as described above, when the massage device passes through the first section P1, the spine is in a state of being normally aligned along the longitudinal direction (X), and thus the loads applied to the first pressing member 110 and the second pressing member 130 are the same. However, when the massage device passes through the second section P2, the spine is in a state of being shifted to one side in the width direction (Y), and thus the loads applied to the first pressing member 110 and the second pressing member 130 are different. Through this, the spinal scoliosis data of the user is collected.

As shown in FIG. 8, the control unit 500 may move the transfer plate member 310 in the longitudinal direction (X) while maintaining the vertical (Z) positions of the first pressing member 110 and the second pressing member 130 fixed, and may measure the degree of spinal scoliosis of the user by utilizing the change in the vertical (Z) positions of the first pressing member 110 and the second pressing member 130 caused by the load applied from the user.

That is, when the spine is normally aligned along the longitudinal direction (X), the vertical (Z) positions of the first pressing member 110 and the second pressing member 130 are changed identically in accordance with the shape of the user's spine. However, when the spine is arranged shifted to one side in the width direction (Y) in a certain section due to spinal scoliosis, the vertical (Z) positions of the first pressing member 110 and the second pressing member 130 are changed differently, and the device is configured to measure the degree of spinal scoliosis of the user based on this. Thus, it is possible to easily determine the degree of spinal scoliosis of the user without using expensive equipment. To this end, the first pressing member 110 and the second pressing member 130 may be configured such that their vertical (Z) positions can freely change according to the user's load applied thereto.

In this case, the control unit 500 may collect spinal scoliosis data of the user by identifying a first section P1 in which the vertical (Z) positions of the first pressing member 110 and the second pressing member 130 are identical, and a second section P2 in which the vertical (Z) positions of the first pressing member 110 and the second pressing member 130 are different.

That is, as described above, when the massage device passes through the first section P1, the spine is normally aligned along the longitudinal direction (X), so the vertical (Z) positions of the first pressing member 110 and the second pressing member 130 are identical. However, when the massage device passes through the second section P2, the spine is disposed shifted to one side in the width direction (Y), so the vertical (Z) positions of the first pressing member 110 and the second pressing member 130 become different, and the spinal scoliosis data of the user is collected accordingly.

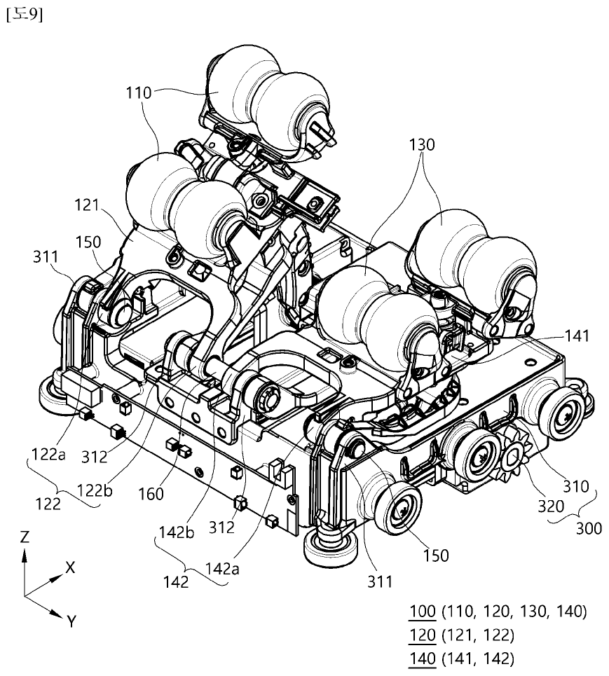

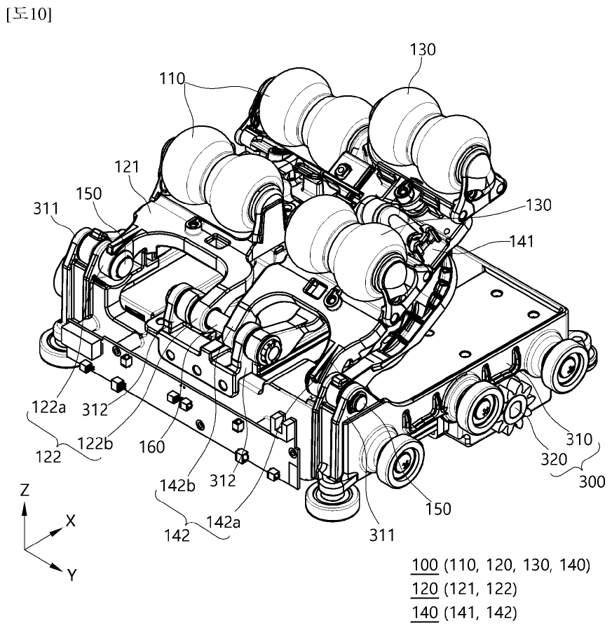

FIG. 9 is a perspective view of a massage device according to an exemplary embodiment of the present invention, illustrating a state in which a pressing member disposed on one side in the width direction is raised, and FIG. 10 is a perspective view of a massage device according to an exemplary embodiment of the present invention, illustrating a state in which a pressing member disposed on the other side in the width direction is raised.

As illustrated in FIG. 3, when the pressing part 100 passes through the first section P1, the control unit 500 controls the vertical (Z) positions of the first pressing member 110 and the second pressing member 130 to be identical.

However, when the pressing part 100 passes through the second section P2, the control unit 500 controls the vertical (Z) positions of the first pressing member 110 and the second pressing member 130 to be different so that the pressing force on one side and the other side in the width direction (Y) becomes different.

That is, as illustrated in FIG. 8, when the second section P2 is formed in which the user's spine is disposed shifted to the other side in the width direction (Y), as the massage device passes through this second section P2, the first pressing member 110 disposed on one side in the width direction (Y) is controlled to ascend, and the second pressing member 130 disposed on the other side in the width direction (Y) is controlled to descend, as illustrated in FIG. 9.

In contrast, when the second section P2 is formed in which the user's spine is disposed shifted to one side in the width direction (Y), as the massage device passes through this second section P2, the first pressing member 110 disposed on one side in the width direction (Y) may be controlled to descend, and the second pressing member 130 disposed on the other side in the width direction (Y) may be controlled to ascend, as illustrated in FIG. 10.

When the user selects a massage mode and inputs a desired pressing force, the control unit 500 adjusts the vertical positions (Z) of the first pressing member 110 and the second pressing member 130 to be identical so that the pressing force is applied while the pressing part 100 passes through the first section P1, as illustrated in FIG. 3.

In addition, the control unit 500 may adjust the vertical positions (Z) of the first pressing member 110 and the second pressing member 130 to be different from each other so that the pressing force is applied while the pressing part 100 passes through the second section P2. That is, in the massage mode, since it is necessary to press the user's body with the pressing force input by the user, when the second section P2 is formed in which the user's spine is disposed shifted to the other side in the width direction (Y), as the massage device passes through this second section P2, the first pressing member 110 disposed on one side in the width direction (Y) is controlled to ascend, and the second pressing member 130 disposed on the other side in the width direction (Y) is controlled to descend. Conversely, when the second section P2 is formed in which the user's spine is disposed shifted to one side in the width direction (Y), as the massage device passes through this second section P2, the first pressing member 110 disposed on one side in the width direction (Y) is controlled to descend, and the second pressing member 130 disposed on the other side in the width direction (Y) is controlled to ascend.

In this case, when the user selects a correction mode, the control unit 500 may, based on the collected spinal scoliosis data of the user, identify one of the first pressing member 110 and the second pressing member 130 to which a relatively smaller load is applied and the other pressing member to which a relatively larger load is applied, and may control the vertical position (Z) of one pressing member to remain fixed while controlling the vertical position (Z) of the other pressing member to increase.

That is, in the correction mode, when passing through the second section P2, the pressing member is controlled such that its height increases in order to press the portion having spinal scoliosis. When the second section P2 is formed in which the user's spine is disposed shifted to the other side in the width direction (Y), as the massage device passes through this second section P2, the height of the first pressing member 110 disposed on one side in the width direction (Y) is kept fixed, and the second pressing member 130 disposed on the other side in the width direction (Y) is controlled to ascend, thereby pressing the portion having spinal scoliosis more strongly to correct the spinal scoliosis. In addition, when the second section P2 is formed in which the user's spine is disposed shifted to one side in the width direction (Y), as the massage device passes through the second section P2, the height of the second pressing member 130 disposed on the other side in the width direction (Y) is kept fixed, and the first pressing member 110 disposed on one side in the width direction (Y) is controlled to ascend, thereby pressing the portion having spinal scoliosis more strongly to correct the spinal scoliosis.

As described above, since the first pressing member 110 and the second pressing member 130 can be independently raised or lowered, the spine of a user whose body is asymmetrical in the width direction (Y) can also be corrected.

As described above, the massage device having a separation-type pressing part according to an exemplary embodiment of the present invention is provided with a first pressing plate member 120 that supports the first pressing member 110 disposed on one side in the width direction (Y) with respect to the user's spine, and a second pressing plate member 140 that supports the second pressing member 130 disposed on the other side in the width direction (Y). The massage device is also provided with a first lifting/lowering member 210 and a first lifting/lowering driving member 220 for raising or lowering the first pressing plate member 120, and a second lifting/lowering member 230 and a second lifting/lowering driving member 240 for raising or lowering the second pressing plate member 140. Accordingly, it is possible to raise or lower the first pressing member 110 and the second pressing member 130 independently of each other, thereby providing an appropriate massage even to a user whose body is asymmetrical on both sides in the width direction (Y), and thus maximizing the massage effect.

Although exemplary embodiments of the present invention have been described above, the spirit of the present invention is not limited to the embodiments set forth herein. Those of ordinary skill in the art who understand the spirit of the present invention may easily propose other embodiments through supplement, change, removal, addition, etc. of elements within the same spirit, but the embodiments will be also within the scope of the present invention.

1. A massage device having a separation-type pressing part, comprising:
a pressing part including a first pressing member and a second pressing member provided along a width direction to press a user's body, and a first pressing plate member and a second pressing plate member respectively supporting the first pressing member and the second pressing member;
a lifting/lowering part including a first lifting/lowering member and a second lifting/lowering member respectively configured to lift or lower the first pressing plate member and the second pressing plate member, and a first lifting/lowering driving member and a second lifting/lowering driving member respectively providing driving forces to the first lifting/lowering member and the second lifting/lowering member; and
a transfer part including a transfer plate member on which the pressing part and the lifting/lowering part are disposed, and a transfer driving member providing a driving force such that the transfer plate member moves along a longitudinal direction.

2. The massage device having a separation-type pressing part according to claim 1,
wherein the first pressing plate member and the second pressing plate member each comprise:
a body on which the first pressing member and the second pressing member are respectively disposed; and
a leg extending from the body and hinge-fixed to the transfer plate member.

3. The massage device having a separation-type pressing part according to claim 2, wherein the leg comprises a first leg disposed outward in the width direction and a second leg disposed inward in the width direction.

4. The massage device having a separation-type pressing part according to claim 3,
wherein a first hinge shaft is provided in the first leg to be hinge-fixed to the transfer plate member,
and a second hinge shaft is provided in the second leg to be hinge-fixed to the transfer plate member.

5. The massage device having a separation-type pressing part according to claim 4, wherein the second hinge shaft is disposed to simultaneously penetrate the second legs that are disposed adjacent to each other.

6. The massage device having a separation-type pressing part according to claim 5,
wherein an outer side in the width direction of the first hinge shaft is fixed to the transfer plate member, and the first leg is fixed to an inner side in the width direction of the first hinge shaft,
and both sides in the width direction of the second hinge shaft are fixed to the transfer plate member, and the second leg is fixed to an inner side in the width direction of the second hinge shaft.

7. The massage device having a separation-type pressing part according to claim 6, wherein the first lifting/lowering member and the second lifting/lowering member respectively support lower surfaces of the first pressing plate member and the second pressing plate member, but support positions inwardly shifted from widthwise centers of the first pressing plate member and the second pressing plate member.

8. The massage device having a separation-type pressing part according to claim 1, further comprising:
a load detection part including load detection members respectively provided in the first pressing member and the second pressing member to respectively measure loads applied to the first pressing member and the second pressing member; and
a control unit configured to control operations of the lifting/lowering part and the transfer part based on signals transmitted through the load detection part.

9. The massage device having a separation-type pressing part according to claim 8,
wherein the control unit is configured to:
move the transfer plate member in the longitudinal direction while maintaining the height direction positions of the first pressing member and the second pressing member fixed, and
measure the degree of spinal scoliosis of a user based on signals respectively transmitted through the load detection members respectively provided in the first pressing member and the second pressing member.

10. The massage device having a separation-type pressing part according to claim 9, wherein the control unit is configured to identify a first section in which loads applied to the first pressing member and the second pressing member are identical, and a second section in which loads applied to the first pressing member and the second pressing member are different, and collect spinal scoliosis data of the user.

11. The massage device having a separation-type pressing part according to claim 9,
wherein the control unit is configured to:
move the transfer plate member in the longitudinal direction while maintaining the height direction positions of the first pressing member and the second pressing member fixed, and
measure the degree of spinal scoliosis of the user by utilizing a change in the height direction positions of the first pressing member and the second pressing member caused by a load applied from the user.

12. The massage device having a separation-type pressing part according to claim 11,
wherein the control unit is configured to identify a first section in which height direction positions of the first pressing member and the second pressing member are identical, and a second section in which the height direction positions of the first pressing member and the second pressing member are different, and to collect spinal scoliosis data of the user.

13. The massage device having a separation-type pressing part according to claim 10
wherein the control unit is configured to:
control the height direction positions of the first pressing member and the second pressing member to be identical when the pressing part passes through the first section, and
control the height direction positions of the first pressing member and the second pressing member to be different so that pressing forces on one side and the other side in the width direction are different when the pressing part passes through the second section.

14. The massage device having a separation-type pressing part according to claim 13,
wherein, when the user selects a massage mode and inputs a desired pressing force,
the control unit is configured to:
adjust the height direction positions of the first pressing member and the second pressing member to be identical so that the pressing force is applied while the pressing part passes through the first section, and
adjust the height direction positions of the first pressing member and the second pressing member to be different respectively so that the pressing force is applied while the pressing part passes through the second section.

15. The massage device having a separation-type pressing part according to claim 13,
wherein, when the user selects a correction mode,
the control unit is configured to:
identify one of the first pressing member and the second pressing member to which a relatively smaller load is applied and the other of the first pressing member and the second pressing member to which a relatively larger load is applied, based on the collected spinal scoliosis data of the user, and
control the height direction position of one of the pressing members to be fixed and the height direction position of the other of the pressing members to be increased.
